(19) United States
(12) Patent Application Publication
(10) Pub. No.: US 2007/0017621 A1
(43) Pub. Date: Jan. 25, 2007

(54) Tire/wheel assembly and pneumatic tire

(75) Inventor: Shinichi Mori, Hiratsuka-shi (JP)

Correspondence Address: RADER FISHMAN & GRAUER PLLC, LION BUILDING, 1233 20TH STREET N.W., SUITE 501, WASHINGTON, DC, 20036, US

(73) Assignee: THE YOKOHAMA RUBBER CO., LTD.

(21) Appl. No.: 11/527,525

(22) Filed: Sep. 27, 2006

Related U.S. Application Data
(62) Division of application No. 10/642,132, filed on Aug. 18, 2003.

(30) Foreign Application Priority Data
Aug. 22, 2002 (JP) JP2002-241398

(51) Int. Cl. B60C 15/00

(52) U.S. Cl. 152/540; 152/513; 152/543

(57) ABSTRACT

An auxiliary member, made of metal or synthetic resin, is disposed between each rim seat of the rim of a wheel and at least a bead base portion of each of the beads of a pneumatic tire fitted to the rim seats.

### BACKGROUND OF THE INVENTION

The present invention relates to a tire/wheel assembly and a pneumatic tire. More specifically, the present invention relates to a tire/wheel assembly and a pneumatic tire, in which the fitting ability of a pneumatic tire to a rim of a wheel can be improved.

In general, a pneumatic tire is attached to a wheel by fitting the beads to its rim seats located outside the rim humps. A pneumatic tire fitted to the rim in this manner possibly brings about a serious accident when the beads come off the rim seats during traveling. This kind of accident is likely to develop into a serious tragic accident especially when traveling on a highway at a high speed. Therefore, it is always demanded to improve the fitting ability of a pneumatic tire to a rim of a wheel in order to prevent such accident.

### SUMMARY OF THE INVENTION

An object of the present invention is to provide a tire/wheel assembly and a pneumatic tire in which the fitting ability of a pneumatic tire to a rim of a wheel can be improved.

In order to achieve the above object, a tire/wheel assembly according to the present invention includes a wheel having a rim, a pneumatic tire having beads attached to rim seats of the rim, and auxiliary members, each of the an auxiliary members being made of metal or synthetic resin and being disposed between the rim seat of the rim and at least a bead base portion of the bead of the pneumatic tire.

A pneumatic tire according to the present invention includes beads each of which has a beadbase portion, at least the bead base portion of the bead being covered with an auxiliary member which is made of metal or synthetic resin.

According to the present invention described above, the beads of the pneumatic tire which are fitted to the rim can be stabilized in shape. Thus, it is possible to ensure the fitting of the pneumatic tire to the rim and increase the rigidity of the bead toe portion. Accordingly, it becomes more difficult for the pneumatic tire to come off the rim. As a result, the fitting ability of the pneumatic tire to the rim can be improved.

### BRIEF DESCRIPTION OF THE DRAWINGS

FIG. 1 is a cross sectional view showing a main part of an embodiment of a tire/wheel assembly according to the present invention.

FIG. 2 is a partially enlarged cross sectional view of an alternative embodiment of a tire/wheel assembly according the present invention.

FIG. 3 is a partially enlarged cross sectional view of another alternative embodiment of a tire/wheel assembly according to the present invention.

FIG. 4 is a partially enlarged cross sectional view of still another alternative embodiment of a tire/wheel assembly according to the present invention.

FIG. 5 is a partially enlarged cross sectional view of still another alternative embodiment of a tire/wheel assembly according to the present invention.

### DETAILED DESCRIPTION OF THE PREFERRED EMBODIMENTS

Embodiments of the present invention will be described below in detail with reference to the attached drawings.

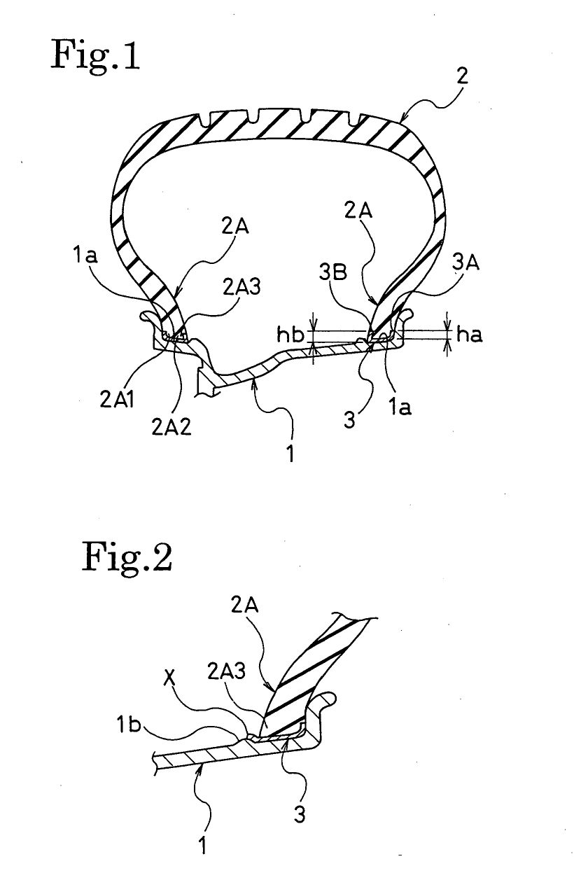

FIG. 1 is a cross sectional view showing a main part of an embodiment of a tire/wheel assembly according to the present invention. Reference numeral 1 denotes a rim positioned in the circumference of a wheel, and reference numeral 2 denotes a pneumatic tire. The tire/wheel assembly has a structure in which the pneumatic tire 2 is attached to the rim 1 by fitting beads 2A of the pneumatic tire 2 to rim seats 1a of the rim 1.

The beads 2A of the pneumatic tire 2 are each provided with an auxiliary member 3 which is a plate-like member made of metal or synthetic resin and circularly formed along a circumferential direction of the tire. Each auxiliary member 3 has a width which extends from a bead heel portion 2A1 to a bead toe portion 2A3 through a bead base portion 2A2, and is tire-radially outwardly bent at the bead heel portion 2A1 and the bead toe portion 2A3 along a surface of the tire to cover the surface of the bead 2A from the bead heel portion 2A1 to the bead toe portion 2A3.

The metal used for the auxiliary member 3 may include, for example, steel and aluminum. The resin used therefore may be thermoplastic resin or thermosetting resin. The thermoplastic resin may be, for example, nylon and polyester. The thermosetting resin may include, for example, epoxy resin and unsaturated polyester resin. The resin can be used as single resin or fiber reinforced resin containing reinforcing fiber.

Tire radial direction heights ha and hb of bent portions 3A and 3B of each auxiliary member 3 are set to 10 mm or lower, and preferably to 5 mm or lower from the viewpoint of the workability of the tire-to-rim fitting. The tire radial direction heights ha and hb are measured, in the depicted meridian cross section of the tire, with reference to an imaginary straight line drawn along a straight extending circumferential surface of the rim seat 1a where the auxiliary member 3 is engaged.

The auxiliary member 3 may have a shape which extends beyond the bead toe portion 2A3 to protrude toward an inner side with respect to the tire width direction in place of the structure which tire-radially outwardly bent at the bead toe portion 2A3 along the tire surface as described above, a protrusion portion X thereof extending along a hump 1b of the rim 1 so as to contact with the hump 1b as shown in FIG. 2.

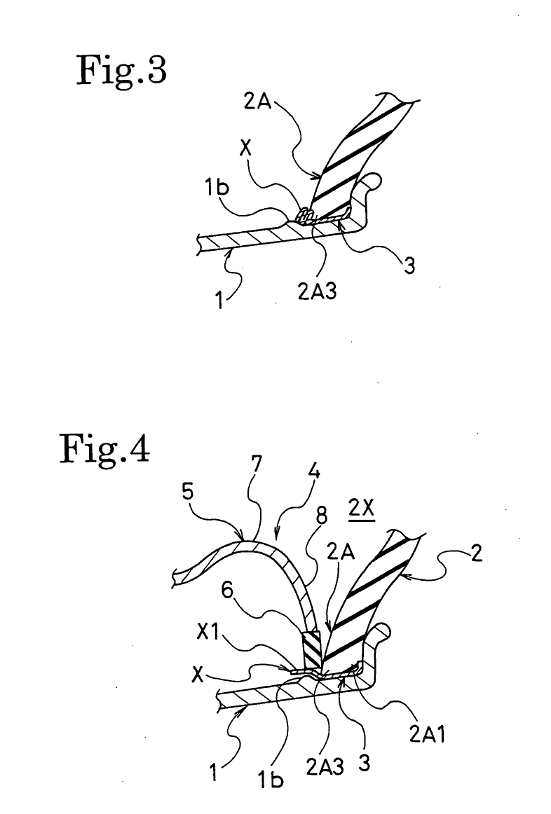

Alternatively, as shown in FIG. 3, the auxiliary member 3 may be formed such that the auxiliary member 3 extends beyond the bead toe portion 2A3 to protrude toward an inner side with respect to the tire width direction and a protrusion portion X thereof is bent in a zigzagged manner to be laminated so as to contact with the hump 1b, forming a thick portion.

According to the present invention described above, since the auxiliary members 3 are disposed between the rim seats 1a of the rim 1 and at least the bead base portions 2A2 of the pneumatic tire 2, the beads 2A attached to the rim 2 can be stabilized in shape. Accordingly, it is possible to ensure the fitting of the pneumatic tire 2 to the rim 1 and enhance the rigidity of the bead toe portion 2A3. Thus, it becomes harder for the pneumatic tire 2 to come off the rim. Therefore, the fitting ability of the pneumatic tire 2 to the rim 1 can be improved.

FIG. 4 illustrates another embodiment of a tire/wheel assembly according to the present invention. In this embodiment, the aforementioned auxiliary member 3 which extends from the bead heel portion 2A1 to the bead toe portion 2A3 is formed such that the auxiliary member 3 extends beyond the bead toe portion 2A3 to protrude toward the tire inner side, and a protrusion portion X thereof is bent along the hump 1b of the rim 1 and extends beyond the hump 1b toward the tire inner side along a wheel rotation axis (not shown), an extension portion X1 thereof being formed as a seat for a run-flat support member 4. When using the extension portion X1 as a seat for the run-flat support member 4 as described above, the auxiliary member 3 is preferably made of metal.

The run-flat support member 4 mentioned above comprises a circular shell 5, and left and right elastic rings 6. The circular shell 5 is made of a rigid material such as metal or resin. The elastic rings 6 are made of an elastic material such as rubber or elastic resin.

The circular shell 5 has a support surface 7 having two convex portions on the outer circumferential side. The support surface 7 is separated from the inner surface of the pneumatic tire 2 when the pneumatic tire 2 is under normal conditions. When the pneumatic tire 2 is punctured, the support surface 7 supports the flat tire. The inner circumferential side of the circular shell 5 is opened to have two sidewalls serving as leg portions 8, and the left and right elastic rings 6 are attached to the inner circumferential sides of the leg portions 8.

The rim 1, pneumatic tire 2 and run-flat support member 4 are concentrically formed in a circle around the wheel rotation axis (not shown). The run-flat support member 4 is disposed in a cavity 2X of the pneumatic tire 2 attached to the rim 1 so as to fit the elastic rings 6 to the extension portions X1 of the protrusion portions X.

In the tire/wheel assembly thus constituted, the run-flat support member 4 can be stably attached in the cavity 2X of the pneumatic tire 2, in addition to the aforementioned effect.

Specifically, the conventionally proposed run-flat support member 4 described above is attached to the rim 1 by seating the inner circumferential end of each elastic ring 6 at a narrow space between the hump 1b of the rim 1 and the bead toe portion 2A3.

However, the space is originally narrow. Due to this insufficient space, it is difficult to stably seat the run-flat support member 4 during run-flat traveling. Depending on the combination of a tire and a rim, the space required for seating cannot be ensured. Therefore, the seat for the run-flat support member 4 is formed by utilizing the auxiliary member 3 which improves the fitting ability as previously mentioned.

Owing to this, it is possible to satisfy both an improvement in the fitting ability of the pneumatic tire 2 to the rim 1 and stable attachment of the run-flat support member 4 simultaneously by use of the auxiliary member 3, without providing an additional member.

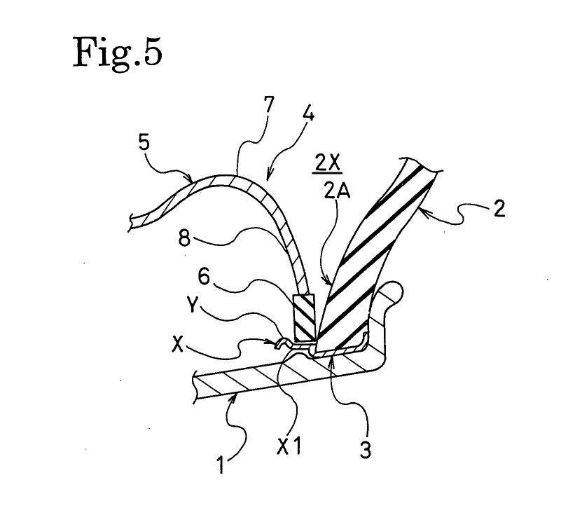

FIG. 5 illustrates still another embodiment of a tire/wheel assembly according to the present invention. In this embodiment, a hump Y for the elastic ring is formed in the tip side of the extension portion X1 of the auxiliary member 3 shown in FIG. 4. The hump Y tire-radially outwardly protrudes by bending the tip portion of the extending portion X1 tire-radially outwardly and further bending it back tire-radially inwardly.

The hump Y makes it difficult for the elastic ring 6 fitted to the extension portion X1 to come off the extension portion X1 during run-flat traveling. Thus, the run-flat support member 4 can be more stably attached to the tire/wheel assembly. Since the tip of the extension portion X1 having the hump Y is tire-radially inwardly bent, the smooth fitting of the elastic ring 6 to the extension portion X1 is not disturbed.

In the present invention, the auxiliary member 3 may be arranged such that it covers at least the bead base portion 2A2 and is disposed between the rim seat 1a and the bead base portion 2A2, when provided at the bead 2A of the pneumatic tire 2, in order to achieve the object of the present invention.

The auxiliary member 3 can be bonded with the bead 2A of the pneumatic tire 2 through vulcanization when vulcanizing the tire. Alternatively, the auxiliary member 3 can be attached by fitting to the bead base 2A of the pneumatic tire 2 after vulcanization.

Having thus explained, since an auxiliary member of metal or synthetic resin is disposed between a rim seat and a bead base portion of a pneumatic tire, the present invention can improve the fitting ability of a pneumatic tire to a wheel rim.

1-10. (canceled)

11. A pneumatic tire having beads each of which has a bead base portion, at least the bead base portion of each of the beads being covered with an auxiliary member which is made of metal or synthetic resin.

12. The pneumatic tire according to claim 11, wherein the auxiliary member extends from a bead toe portion to a bead heel portion, which are respectively located on each side of the bead base portion, and wherein the auxiliary member is tire-radially outwardly bent on each side thereof along a surface of the tire, and a tire radial direction height of each of the bent portions is set to 10 mm or lower.

13. The pneumatic tire according to claim 11, wherein the auxiliary member have a shape which extends beyond a bead toe portion of the bead to protrude toward an inner side with respect to a width direction of the tire, a protrusion portion thereof extending along a hump of the rim.

14. The pneumatic tire according to claim 11, wherein the auxiliary member have a shape which extends beyond a bead toe portion of the bead to protrude toward an inner side with respect to a width direction of the tire, a protrusion portion thereof is formed as a thick portion so as to contact with a hump of the rim.

15. The pneumatic tire according to claim 11, wherein the auxiliary member is arranged such that the auxiliary member extends beyond a bead toe portion of the bead to protrude toward an inner side with respect to a width direction of the tire, a protrusion portion thereof being bent along a hump of the rim and extending beyond the hump toward the inner side with respect to a width direction of the tire.

16. The pneumatic tire according to claim 15, wherein an extension portion of the protrusion portion has a tire-radially outwardly protruding hump in a tip side thereof.

17. The pneumatic tire according to claim 16, wherein the hump is formed by bending a tip portion of the extension portion tire-radially outwardly and further bending it back tire-radially inwardly.
